(19) United States
(12) Patent Application Publication
(10) Pub. No.: US 2025/0214519 A1
(43) Pub. Date: Jul. 3, 2025

(54) VEHICLE WIRING SYSTEM AND VEHICLE ADDITIONAL WIRING MEMBER

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP); TOYOTA JIDOSHA KABUSHIKI KAISHA, Aichi (JP)

(72) Inventors: Masami ONO, Osaka (JP); Kosuke SONE, Osaka (JP); Tomoka SHIDA, Osaka (JP); Daichi ASHIDA, Mie (JP); Yoshikazu HACHIYA, Osaka (JP); Tatsumi SATO, Mie (JP); Makoto CHUJO, Osaka (JP); Shinji OSHITA, Aichi (JP); Kanade KURIYAMA, Aichi (JP); Ikuyoshi OTAKE, Aichi (JP); Hiroki SHUKURI, Aichi (JP); Itsuo WAKABAYASHI, Aichi (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP); TOYOTA JIDOSHA KABUSHIKI KAISHA, Aichi (JP)

(21) Appl. No.: 18/849,584

(22) PCT Filed: Mar. 16, 2023
(86) PCT No.: PCT/JP2023/010322

§ 371 Date: Sep. 23, 2024

(30) Foreign Application Priority Data
Mar. 28, 2022 (JP) 2022-051644

(51) Int. Cl. B60R 13/02; B60R 16/02; H02G 3/30

(52) U.S. Cl. CPC B60R 13/025; B60R 13/0206; B60R 16/0215; H02G 3/305

(57) ABSTRACT

A vehicle wiring system includes: an interior member facing a vehicle interior; an additional wiring member disposed on the interior member from a side of the vehicle interior; and an additional interior member. The additional interior member covers the additional wiring member from a side opposite to the interior member.

### TECHNICAL FIELD

The present disclosure relates to a vehicle wiring system and a vehicle additional wiring member.

### BACKGROUND ART

Patent Document 1 discloses a technique of embedding a wire harness for an electric component into a weather-strip holding a rear glass, and fixedly providing a connector connected to each electric component or a connector for being connected to a main harness to the weather-strip while being exposed outside.

### PRIOR ART DOCUMENTS

### Patent Document(s)

Patent Document 1: Japanese Patent Application Laid-Open No. 10-24782

### SUMMARY

### Problem to Be Solved by the Invention

It is desired that a wiring member can be easily added in accordance with additional mounting of an electrical component in a vehicle.

Accordingly, an object of the present disclosure is to be able to easily add a wiring member to a vehicle.

### Means to Solve the Problem

A vehicle wiring system according to the present disclosure is a vehicle wiring system including: an interior member facing a vehicle interior; an additional wiring member disposed on the interior member from a side of the vehicle interior; and an additional interior member covering the additional wiring member from a side opposite to the interior member.

A vehicle additional wiring member according to the present disclosure is a vehicle additional wiring member including: an additional wiring member disposed on an interior member facing a vehicle interior; and an additional interior member covering the additional wiring member from a side opposite to the interior member.

### Effects of the Invention

According to the present disclosure, a wiring member can be easily added to a vehicle.

### BRIEF DESCRIPTION OF DRAWINGS

FIG. 1 is a schematic perspective view illustrating a part of a vehicle into which a vehicle wiring system according to an embodiment is incorporated.

FIG. 2 is a partial enlarged view illustrating the vehicle wiring system.

FIG. 3 is a cross-sectional view along a III-III line in FIG. 1.

FIG. 4 is a schematic plan view illustrating an additional interior member according to a modification example.

FIG. 5 is a partial enlarged view illustrating another vehicle wiring system.

FIG. 6 is an explanation view illustrating a positional relationship of each part along a VI-VI line cross section in FIG. 1.

### DESCRIPTION OF EMBODIMENT(S)

### Description of Embodiments of Present Disclosure

Embodiments of the present disclosure are listed and described firstly.

A vehicle wiring system according to the present disclosure is as follows.

(1) A vehicle wiring system includes: an interior member facing a vehicle interior; an additional wiring member disposed on the interior member from a side of the vehicle interior; and an additional interior member covering the additional wiring member from a side opposite to the interior member.

According to the present vehicle wiring system, the additional wiring member is disposed on the interior member, and the additional wiring member can be covered by the additional interior member. Accordingly, the additional wiring member can be easily added indistinctively to the vehicle without detaching the interior member once.

(2) In the vehicle wiring system according to (1), it is applicable that the additional wiring member includes a part from a first edge part toward a second edge part of the inner member, and the additional interior member includes a part wholly covering the part between the first edge part and the second edge part in the additional wiring member. Accordingly, the additional wiring member and the additional interior member are hardly noticeable on the interior member.

(3) The vehicle wiring system according to (1) or (2) may further include a wiring member covered by the interior member from the side of the vehicle interior. Accordingly, the additional wiring member can be added without reworking the existing wiring member.

(4) In the vehicle wiring system according to any one of (1) to (3), the additional interior member may be a sheet deformable along a surface shape of the interior member. Accordingly, the additional interior member is easily disposed along a surface of the interior member regardless of the surface shape of the interior member.

(5) In the vehicle wiring system according to any one of (1) to (3), the additional interior member may be a member having rigidity to an extent of being able to form a space for locating the additional wiring member between the interior member and the additional interior member. The additional interior member is disposed on the interior member, thus the space for locating the additional wiring member can be provided.

(6) In the vehicle wiring system according to (5), it is applicable that the interior member is a liner covering a vehicle interior side of a pillar, and the additional interior member is an additional liner covering the liner from the side of the vehicle interior. Accordingly, the additional wiring member following the pillar can be easily added.

(7) In the vehicle wiring system according to any one of (1) to (6), a color of a surface of the additional interior member may be a same type of color as a color of a surface of the interior member. Accordingly, the additional interior member is hardly noticeable.

(8) In the vehicle wiring system according to any one of (1) to (7), design texture of the surface of the additional interior member may be a same as design texture of the surface of the interior member. Accordingly, the additional interior member is hardly noticeable.

(9) In the vehicle wiring system according to any one of (1) to (8), at least a part of an edge of the additional interior member may be along an edge of the interior member. Accordingly, the additional interior member is hardly noticeable.

(10) In the vehicle wiring system according to any one of (1) to (9), the additional interior member may include an impact absorption layer. Accordingly, impact on the additional wiring member is suppressed.

(11) In the vehicle wiring system according to any one of (1) to (10), the additional interior member may be kept in a state of covering the additional wiring member by an adhesive layer or a hook and loop fastener. Accordingly, the additional interior member is easily attached to the interior member, for example.

A vehicle additional wiring member according to the present disclosure is as follows.

(12) A vehicle additional wiring member includes: an additional wiring member disposed on an interior member facing a vehicle interior; and an additional interior member covering the additional wiring member from a side opposite to the interior member.

According to the present vehicle additional wiring member, the additional wiring member is disposed on the interior member, and the additional wiring member can be covered by the additional interior member. Accordingly, the additional wiring member can be easily added indistinctively to the vehicle without detaching the interior member once.

### Detailed Description of Embodiment of Present Disclosure

Specific examples of a vehicle wiring system and a vehicle additional wiring member of the present disclosure are described hereinafter with reference to the drawings. The present disclosure is not limited to these examples, but is indicated by claims, and it is intended that meanings equivalent to claims and all modifications within a scope of claims are included.

### EMBODIMENT

### Whole Schematic Configuration

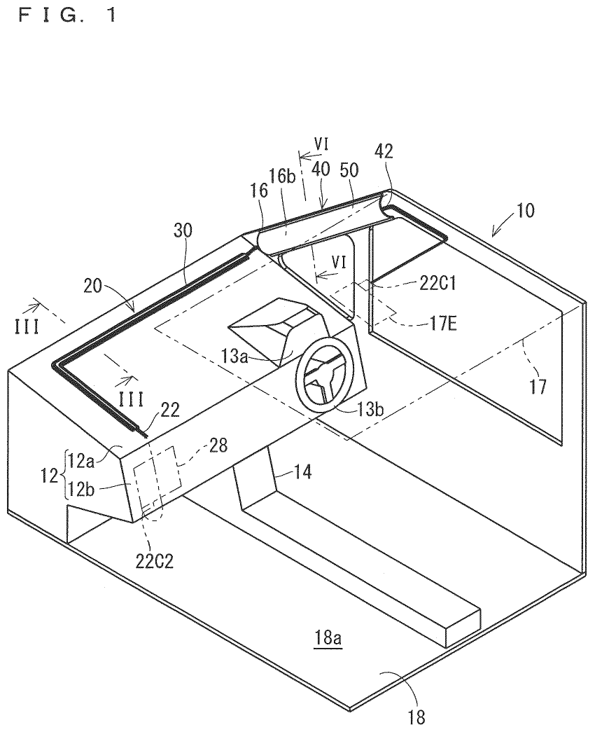

A vehicle wiring system and a vehicle additional wiring member according to an embodiment are described hereinafter. FIG. 1 is a schematic perspective view illustrating a part of a vehicle 10 into which vehicle wiring systems 20 and 40 are incorporated.

The vehicle 10 is an automobile, for example. In the example illustrated in FIG. 1, the vehicle 10 includes an instrument panel 12, a center console 14, a pillar 16, and a floor 18.

The instrument panel 12 is located in front of a driver seat and a front passenger seat. An instrument 13a such as a speedometer is incorporated into the instrument panel 12. The instrument panel 12 includes an upper panel part 12a directed to an upper side and a back panel part 12b directed to a back side with respect to a forward direction of the vehicle 10. The back panel part 12b is continuously formed with a back edge part of the upper panel part 12a. The back panel part 12b has a posture closer to a gravity direction than the upper panel part 12a. The upper panel part 12a and the back panel part 12b are continuously formed to have a corner or a curved line. A steering wheel 13b is provided to be directed to a back side from the instrument panel 12.

The center console 14 is a part from a center of the instrument panel 12 in a vehicle

width direction toward the back side. The center console 14 separates the driver seat and the front passenger seat. A shift lever, various switches, and a housing part such as a drink holder may be provided to the center console 14.

The pillar 16 is a part supporting a roof 17 against a vehicle body. FIG. 1 illustrates a so-called A pillar in a forefront part. A lower end portion of the pillar 16 is located near a front corner part of one lateral part of the instrument panel 12. An upper end portion of the pillar 16 is located near a front corner part of one lateral part of the roof 17.

The floor 18 is a part extending to a lower back part of the center console 14. A floor carpet 18a is spread on the floor 18.

In the present embodiment, the vehicle wiring system 20 is incorporated into the instrument panel 12 described above, and a vehicle wiring system 40 is incorporated into the pillar 16. The vehicle wiring systems 20 and 40 are described separately.

### Vehicle Wiring System 20

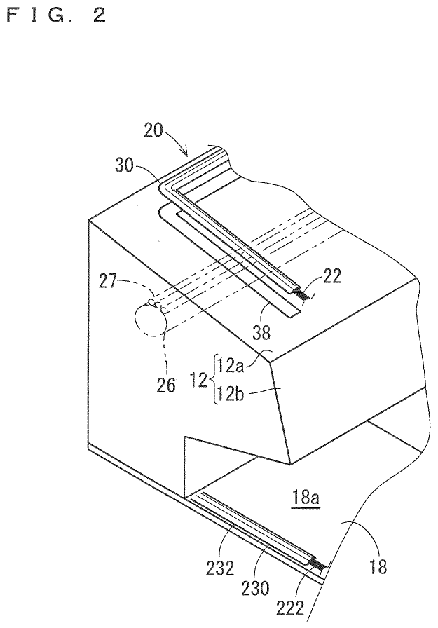

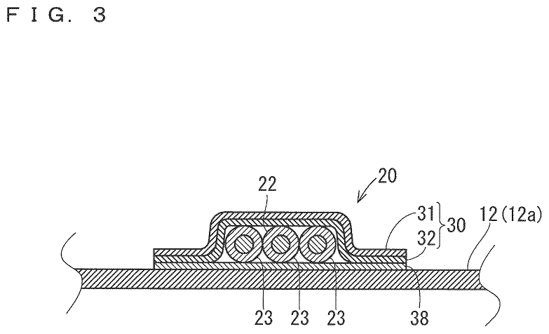

FIG. 2 is a partial enlarged view illustrating the vehicle wiring system 20. FIG. 2 illustrates a part of a left side of the instrument panel 12. FIG. 2 illustrates an additional interior member 30 separated from the instrument panel 12. FIG. 3 is a cross-sectional view along a III-III line in FIG. 1. The vehicle wiring system 20 includes the instrument panel 12, an additional wiring member 22, and the additional interior member 30.

The instrument panel 12 is an example of an interior member facing a vehicle interior. The interior member is a part which can be observed from an inner side of a vehicle in a state before the additional interior member is added. When the additional wiring member is added to the interior member, the interior member is partially or wholly covered by the additional wiring member. The instrument panel 12 is formed of resin, for example, and covers a reinforcement 26 and a wiring member 27, for example, located in front of the driver seat and the front passenger seat from a side of the vehicle interior. The reinforcement 26 is an elongated member formed by metal, for example. The reinforcement 26 is a reinforcement member extending along the vehicle width direction. The wiring member 27 is a wiring member connected to various electrical components 28 disposed inside the instrument panel 12 or assembled to the instrument panel 12. The wiring member 27 extends along the reinforcement 26, and is connected to the electrical component 28 around the reinforcement 26, for example.

The electrical component as a connection destination of the wiring member 27 is an electrical component disposed inside the instrument panel 12 or assembled to the instrument panel 12, for example. For example, the wiring member 27 is connected to an electronic control unit (ECU) disposed in the instrument panel 12 as the electrical component. For example, the wiring member 27 may be connected to the instrument 13a, an operation switch, or an audio instrument assembled to the instrument panel 12 as the electrical component.

The additional wiring member 22 is a wiring member connecting electrical components mounted to a vehicle. The additional wiring member 22 includes at least one electrical wire 23, for example. The electrical wire 23 includes a core wire and a coating around the core wire. The electrical wire 23 may be made of a plurality of stranded electrical wires. The electrical wire 23 may include a shield layer on an outer periphery. The additional wiring member may include at least one of a signal wire and a power wire. The additional wiring member 22 may include the other wiring member such as flexible printed circuits (FPC) in which a circuit made of a metal foil on a resin film is formed, for example, in addition to or in place of the electrical wire 23 in which the covering covers the core wire.

The additional wiring member 22 is disposed on the instrument panel 12 described above from the side of the vehicle interior. In the present embodiment, the additional wiring member 22 including the plurality of electrical wires 23 is disposed to be directed from one lateral part of the upper panel part 12a toward the other lateral part, and is bended to be directed to the back side near the other lateral part on an upward surface of the upper panel part 12a of the instrument panel 12. One end portion of the additional wiring member 22 is guided to the roof 17 through the pillar 16, for example. A connector 22C1 provided to one end portion of the additional wiring member 22 is connected to a roof electrical component 17E provided to the roof 17. The other end portion of the additional wiring member 22 is guided toward a lower opening of the instrument panel 12 in front of the front passenger seat, and is led in the instrument panel 12 through the opening, for example. A connector 22C2 provided to the other end portion of the additional wiring member 22 is connected to the electrical component 28 in the instrument panel 12.

The additional interior member 30 covers the additional wiring member 22 from a side opposite to the instrument panel 12. The additional interior member 30 may wholly or partially cover a part of the additional wiring member 22 disposed on the instrument panel 12. In FIG. 1, the additional interior member 30 covers an intermediate part of the additional wiring member 22 other than both end portions of a part thereof disposed on the upper panel part 12a.

In the present embodiment, the additional interior member 30 is a sheet deformable along a surface shape of the instrument panel 12. The additional interior member 30 may be made up of a resin sheet of polyvinyl chloride or polypropylene, for example. When the additional interior member 30 is the sheet deformable along the surface shape of the instrument panel 12, even in a case where the surface shape of the instrument panel 12 is not a flat surface shape but is a bended shape, the additional interior member can be bended along the bended shape to cover the additional wiring member 22 on the surface of the instrument panel 12.

The additional interior member 30 may include an impact absorption layer 32. The impact absorption layer is a layer excellent in impact absorption properties, and is a foam layer or a non-woven layer made of a plurality of entangled fibers. FIG. 3 illustrates an example that the additional interior member 30 has a multilayer structure of a solid layer 31 with a filled material and the impact absorption layer 32. In this case, it is sufficient that the solid layer 31 is located on the side of the vehicle interior and the impact absorption layer 32 is located on a side of the additional wiring member 22.

The additional interior member 30 may have a single layer structure or a multilayer structure. For example, the additional interior member 30 may have a single layer structure of only the solid layer 31.

A shape of the additional interior member 30 is optionally set. For example, the additional interior member 30 may be formed into a band-like shape extending along a route of the additional wiring member 22. In FIG. 1 and FIG. 2, the additional wiring member 22 extends along an L-like route on the upper panel part 12a, and the additional interior member 30 is also formed into an L-like band shape in accordance with the route.

The additional interior member 30 may be cut to be bended along the route. The additional interior member 30 may be formed to follow a bended route by bending a member having a straight band-like shape or connecting a plurality of straight band-like members.

The additional interior member 30 may have a shape extending along a straight route or have a shape widely spread regardless of the route of the additional wiring member 22. For example, the additional interior member 30 may have a sheet-like shape of being spread to the whole upper panel part 12a. The additional interior member 30 may be a sheet which can be cut with scissors or a cutter, for example. In this case, the additional interior member 30 can be easily cut in accordance with the route of the additional wiring member 22 or an outline shape of the upper panel part 12a, for example.

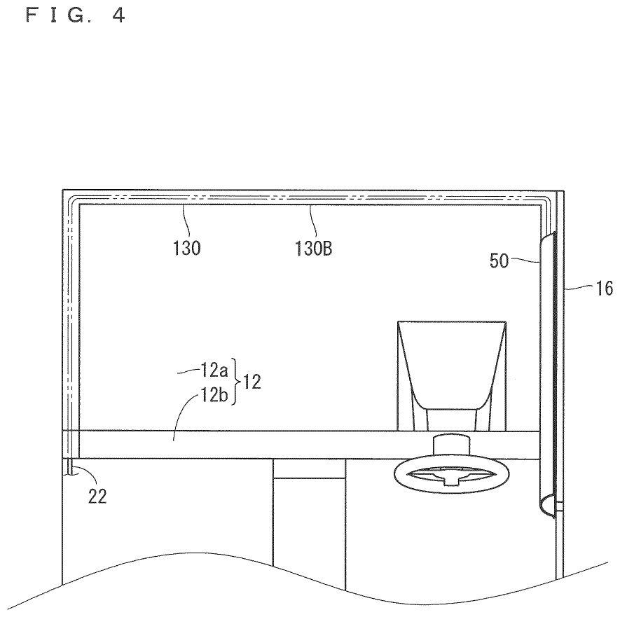

FIG. 4 illustrates an additional interior member 130 according to a modification example in which the shape of the additional interior member 30 is changed. In the present modification example, the additional wiring member 22 is disposed on the upper panel part 12a to follow a whole edge of a front side of the upper panel part 12a from a part of a front side of one lateral edge of the upper panel part 12a and follow the other lateral edge of the upper panel part 12a. A part of the additional wiring member 22 following the whole edge of the front side of the upper panel part 12a is a part following the vehicle width direction.

The additional interior member 130 is formed into a band-like shape to follow the whole edge of the front side of the upper panel part 12a from the part of the front side of one lateral edge of the upper panel part 12a and follow the other lateral edge of the upper panel part 12a. A part 130B of the additional interior member 130 following the whole edge of the front side of the upper panel part 12a from the part of the front side of the upper panel part 12a is an example of a part covering the instrument panel 12 over the whole instrument panel 12 in the vehicle width direction. An edge of an outer side of the part 130B in the vehicle width direction coincides with an edge of an outer side of the instrument panel 12 in the vehicle width direction, thus the additional interior member 130 is hardly noticeable on the instrument panel 12.

An edge of the additional interior member 130 on a front side and an edge thereof an outer side in the vehicle width direction in an edge around the additional interior member 130 follows the edge of the instrument panel 12 on a front side and an edge thereof on an outer side. At least a part of the edge of the additional interior member 130 follows the edge of the additional interior member 130, thus the edge of thereof is hardly noticeable.

When the front side of one lateral edge of the upper panel part 12a is a first edge part and the front side of the other lateral edge of the upper panel part 12a is a second edge part, the additional wiring member 22 includes a part from the first edge part toward the second edge part. It is also considered that the additional interior member 130 covers the whole part of the additional interior member 30 between the first edge part and the second edge part. The additional wiring member 22 is hardly noticeable, and the part of the additional interior member 130 on a side between the first edge part and the second edge part blends into the first edge part and the second edge part of the upper panel part 12a, and is hardly noticeable.

When the additional interior member extends to the same region as the upper panel part 12a, the whole edge around the additional interior member follows an outer edge of the upper panel part 12a and a boundary between the upper panel part 12a and the back panel part 12b, thus the additional interior member is more hardly noticeable.

When at least a part of the edge of the additional interior member follows at least a part of the edge of the interior member, the additional interior member is hardly noticeable. The edge of the interior member in this case may follow a boundary between the interior member and the other interior member in a case where the interior member is located adjacent to the other interior member.

A color of a surface of the additional interior member 30 may be the same type of color as a color of a surface of the instrument panel 12. For example, when a color is classified into thirteen types of colors, that is achromatic colors of white, grey, and black and chromatic colors of red, poppy red, yellow, yellow-green, green, blue-green, blue, blue-purple, purple, red-purple according to JIS Z 8102:2001, a color belonging to the same type may be considered the same type of color.

Design texture of the surface of the additional interior member 30 may be the same as that of the surface of the instrument panel 12 as the interior member. The design texture indicates a pattern of a surface of a component, a processing state, and a minute shape of a surface which may visually give an impression. For example, when the surface of the instrument panel 12 is a wood grain pattern, a marble pattern, a grained pattern, a pear-shaped pattern, a glossy surface, or a metallic surface, it is sufficient that the surface of the additional interior member 30 also has the same pattern or texture as the surface of the instrument panel 12.

The additional interior member 30 is attached to the instrument panel 12 or a member around the instrument panel 12 while covering the additional wiring member 22. In the present example, the additional interior member 30 is attached to the surface of the instrument panel 12. The additional interior member 30 may be attached by an adhesive layer or a hook and loop fastener.

The adhesive layer may be an adhesive layer formed on both surfaces of a base material such as a double-sided adhesive tape or a gluing agent. In FIG. 3, a double-sided adhesive tape 38 is attached to the instrument panel 12. The plurality of electrical wires 23 arranged side by side are attached to the double-sided adhesive tape 38. The additional interior member 30 protrudes to both sides from the plurality of electrical wires 23 arranged side by side, and is attached to the double-sided adhesive tape 38. When the additional wiring member is an adhesive tape-like member in which an adhesive layer is formed on one main surface of a band-like base material, it is applicable that the additional wiring member is attached to the plurality of electrical wires 23 and the adhesive layer exposing to both sides of the additional wiring member 22 is attached to the instrument panel 12.

The additional interior member 30 may be attached to a member around the instrument panel 12. The additional interior member 30 may be attached to the instrument panel 12 or a member around the instrument panel 12 by a hooking structure such as a clip or a locking structure.

The hook and loop fastener is a flat member having a plurality of hook-like members. The hook and loop fastener is a member in which the hook-like member is caught in a loop-like part or fibers on a counterpart side, thereby being detachably caught in the counterpart member. It is sufficient that the hook and loop fastener may be bonded or sewn to the additional interior member 30. The counterpart member may be bonded to the instrument panel 12. When the interior member includes the loop-like part or the fibers, the additional interior member is detachably attached to the interior member directly by the hook and loop fastener.

FIG. 2 illustrates an example that an additional wiring member 222 and an additional interior member 230 are attached to the floor carpet 18a as an example of the interior member. The floor carpet 18a is a carpet in which a plurality of fibers are entangled or a carpet on which a loop-like raising treatment is performed, for example. The floor carpet 18a covers a metal vehicle body floor. The floor carpet 18a may cover the wiring member disposed on the vehicle body floor. The floor carpet 18a is an example of an interior member facing the vehicle interior. The additional wiring member 222 is disposed on the floor carpet 18a. The additional interior member 230 is disposed on the floor carpet 18a to cover the additional wiring member 222. A hook and loop fastener 232 is attached to one main surface of the additional interior member 230 with bonding or sewing, for example. The hook-like member of the hook and loop fastener 232 is caught in the fibers or the loop formed by the raising treatment of the floor carpet 18a on both sides of the additional wiring member 222, thus the additional interior member 230 is detachably attached to the floor carpet 18a while covering the additional wiring member 222.

The additional wiring member 222 may include a part from a first edge part toward a second edge part of the floor carpet 18a. The second edge part is a part away from the first edge part. For example, the first edge part and the second edge part are edges on right and left sides of the floor carpet 18a, and the additional wiring member 22 is disposed over the vehicle width direction in some cases. The first edge part and the second edge part are edges on front and back sides of the floor carpet 18a, and the additional wiring member 22 is disposed over a front-back direction of the vehicle in some cases. The first edge part is an edge on the front or back side of the vehicle, the second edge part is an edge on the right or left side of the vehicle, and the additional wiring member 222 is bended and disposed to be directed from the front or back side toward a lateral side of the vehicle in some cases. The additional wiring member 222 may include a route part detouring between the first edge part and the second edge part.

In this case, it is sufficient that the additional interior member covers the floor carpet 18a while covering the whole part between the first edge part and the second edge part of the additional wiring member 222.

Accordingly, at least a part of the edge of the outer periphery of the additional interior member blends into the first edge part and the second edge part, and the additional wiring member 222 and the additional interior member are also hardly noticeable. The additional wiring member 222 is covered by the additional interior member, thus achievable are measures against disconnection of the additional wiring member 222 due to stepping by a passenger and measures against water on the additional wiring member 222.

### Vehicle Wiring System 40

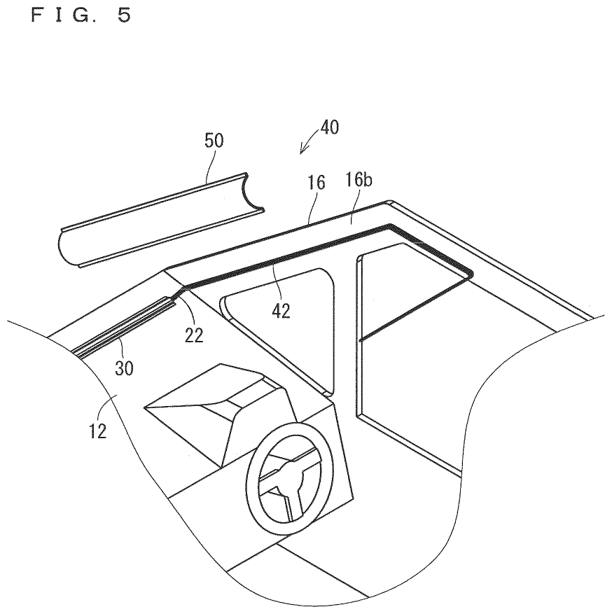

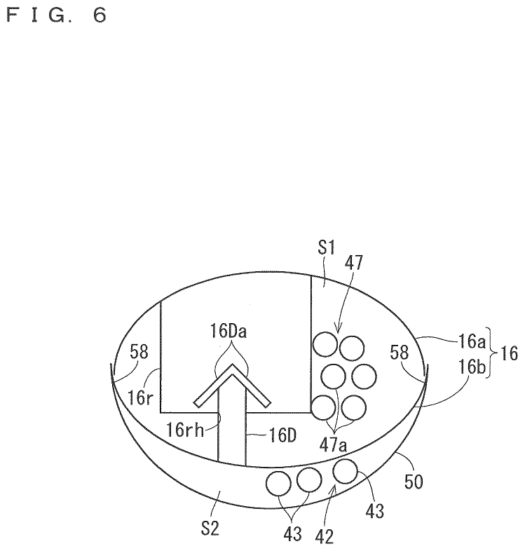

FIG. 5 is a partial enlarged view illustrating the vehicle wiring system 40. FIG. 5 illustrates an additional liner 50 separated from the pillar 16. FIG. 6 is an explanation view illustrating a positional relationship between the pillar 16, a wiring member 47, an additional wiring member 42, and the additional liner 50 at a cross section along a VI-VI line in FIG. 1. The vehicle wiring system 40 is applied to the pillar 16, and includes a liner 16b and the additional liner 50.

The pillar 16 is described herein. The pillar 16 includes a metal pillar 16a and a liner 16b covering the metal pillar 16a from the side of the vehicle interior. The metal pillar 16a is a part of the metal body. The metal pillar 16a has an outer surface exposing outside the vehicle body. A metal reinforcement member 16r may be welded to the metal pillar 16a on the side of the vehicle interior to support the roof 17, for example. The liner 16b is a member formed of resin, for example. The liner 16b is formed into a semi-cylindrical shape, for example. Both end portions of the liner 16b are disposed in positions corresponding to both upper and lower ends of the metal pillar 16a. Both side edges of the liner 16b are disposed along both side edges of the metal pillar 16a. The liner 16b is attached to the metal pillar 16a by a fitting structure, for example. For example, a locking member 16D having a locking claw 16Da protrudes on a side of an inner surface of the liner 16b. A locking hole 16rh to which the locking member 16D is fitted and locked is formed in the metal reinforcement member 16r. The locking member 16D is locked to the locking hole 16rh, thus the liner 16b is attached to the metal pillar 16a. The structure of attaching the liner 16b to the metal pillar 16a is not limited to the example described above. For example, it is applicable that both side edges of the liner 16b are fitted to grooves provided to both side edges of the metal pillar 16a, and the liner 16b is attached to the metal pillar 16a. Moreover, the liner 16b may be attached to the metal pillar 16a by a screw, an adhesive agent, or a gluing agent, for example.

A space where the wiring member 47 can be disposed is formed between the metal pillar 16a and the liner 16b while the liner 16b is attached to the metal pillar 16a. For example, the metal pillar 16a is formed into a semi-cylindrical shape, and the liner 16b is formed into a semi-cylindrical shape. An elongated space is formed between the metal pillar 16a and the liner 16b integrated with each other. An elongated space S1 where the wiring member 47 can be disposed is formed on an outer side of the metal reinforcement member 16r in the elongated space. The liner 16b is a member formed of resin such as polypropylene and having rigidity, and can keep the space S1 described above in a constant shape, for example. The liner 16b is an example of an interior member facing the vehicle interior.

The wiring member 47 is disposed in the space S1 described above. The wiring member 47 includes a plurality of electrical wires 47a, for example, and extends along the pillar 16. One end of the wiring member 47 is connected to an electrical component (for example, a lamp or a camera) on a side of the roof 17 via a connector, for example, and the other end of the wiring member 47 is connected to an electrical component (for example, an ECU or a battery) on a lower side of the roof 17 via a connector, for example. The additional wiring member 42 is disposed on the liner 16b described above. The additional wiring member 42 is a wiring member connecting electrical components mounted to a vehicle. The additional wiring member 42 includes at least one electrical wire 43, for example. In the present embodiment, the additional wiring member 42 is provided to an extension of the additional wiring member 22. The additional wiring member 42 may be a wiring member different from the additional wiring member 22. The additional wiring member 42 may include a wiring member, which is not the electrical wire 43 described above, such as flexible printed circuits (FPC) in which a circuit made of a metal foil on a resin film is formed, for example.

The additional wiring member 42 is disposed on the liner 16b described above from the side of the vehicle interior. In the present embodiment, the additional wiring member 42 including the plurality of electrical wires 43 is disposed to extend from a lower end portion to an upper end portion of the liner 16b in a surface of the liner 16b facing the vehicle interior. One end portion of the additional wiring member 42 is connected to a roof electrical component 17E provided to the roof 17 via the connector 22C1, for example. The other end portion of the additional wiring member 42 is connected to the electrical component 28 located in a position lower than the pillar 16 via the connector 22C2, for example.

The additional liner 50 covers the additional wiring member 42 from a side opposite to the liner 16b. The additional liner 50 may wholly or partially cover a part of the additional wiring member 42 disposed on the liner 16b. In the present embodiment, the additional liner 50 covers the additional wiring member 42 over the whole pillar 16 in the longitudinal direction.

In the present embodiment, the additional liner 50 has rigidity to an extent of being able to form a space S2 for locating the additional wiring member 42 between the liner 16b and the additional liner 50. For example, the additional liner 50 is formed of resin such as polypropylene, and has a thickness to an extent of being able to maintain the space S2. Thus, even when a hand of a person has contact with the additional liner 50 from the side of the vehicle interior, the space S2 described above is kept to have a constant size, and the additional wiring member 42 in the space S2 is hardly compressed.

The additional liner 50 may be formed into a semi-cylindrical shape so that the space S2 described above can be formed in the liner 16b on the side of the vehicle interior, for example. The present additional liner 50 is located over the liner 16b on the side of the vehicle interior, thus the space S2 having a crescentic shape in cross section is formed between the surface of the liner 16b on the side of the vehicle interior and the additional liner 50. Both side edge parts of the additional liner 50 may extend along both side edges of the liner 16b. Accordingly, the additional liner 50 is hardly noticeable when the pillar 16 is seen from the side of the vehicle interior.

A color of a surface of the additional liner 50 may be the same type of color as a color of the surface of the liner 16b. Design texture of the surface of the additional liner 50 may be the same as that of the surface of the liner 16b. The surface of the liner 16b has an aspect consistent with the whole interior, thus even in a case where the additional liner 50 covers the whole liner 16b, the additional liner 50 is hardly noticeable when the surface of the additional liner 50 has the aspect described above.

The additional liner 50 is attached to the liner 16b or a member around the liner 16b while covering the additional wiring member 42. In the present example, the additional liner 50 is attached to the surface of the liner 16b. The additional liner 50 may be attached by an adhesive layer 58 or a hook and loop fastener.

The adhesive layer may be an adhesive layer formed on both surfaces of a base material such as a double-sided adhesive tape or a gluing agent which is applied. In FIG. 6, the adhesive layer 58 by a double-sided adhesive tape is formed on both side edges of the surface of the additional liner 50 facing the liner 16b, and the adhesive layer 58 adheres to both side surfaces of the surface of the liner 16b on the side of the vehicle interior.

The additional liner 50 may be attached to the liner 16b or a member around the liner 16b by an adhesive agent or a hooking structure, for example.

### Effect etc.

According to the wiring systems 20 and 40, the vehicle additional wiring member including the additional wiring member 22 and the additional interior member 30, or the vehicle additional wiring member including the additional wiring member 42 and the additional liner 50 having the above configurations, the additional wiring members 22 and 42 can be disposed on the instrument panel 12 or the liner 16b as the interior members, and can be covered by the additional interior member 30 or the additional liner 50. Accordingly, the additional wiring members 22 and 42 can be easily added indistinctively to the vehicle without detaching the instrument panel 12 or the liner 16b once. The additional wiring members 22 and 42 are covered by the additional interior member 30 or the additional liner 50, thus are not separated and caught in a surrounding object or a person, but are kept in a state of following a constant route.

The instrument panel 12 or the liner 16b as the interior member covers the wiring members 27 and 47, and the additional wiring members 22 and 42 are disposed along routes different from those of the wiring members 27 and 47. Thus, the additional wiring members 22 and 42 can be added without reworking the existing wiring members 27 and 47. The existing wiring members 27 and 47 need not be reworked, thus suppressed are that the positions of the wiring members 27 and 47 are changed and influence of noise increases, for example.

Thus, in the case where the other electrical component is added to the existing vehicle, the present wiring systems 20 and 40 are appropriate as the system for easily adding the additional wiring members 22 and 42 for the electrical component.

The additional interior member 130 includes the whole part covering the instrument panel 12 in the vehicle width direction, thus a part where the additional interior member 130 is disconnected hardly occurs in the intermediate part of the instrument panel 12 in the vehicle width direction, and the outer peripheral edge of the additional interior member 130 is hardly noticeable.

When the additional interior member 30 is the sheet deformable along the surface shape of the instrument panel 12, the additional interior member 30 can be easily disposed along the surface of the interior member regardless of the surface shape of the interior member.

When the additional liner 50 as the additional interior member has the member having rigidity to the extent of being able to form the space S2 for locating the additional wiring member 42 between the liner 16b and the additional liner 50, the space S2 locating the additional wiring member 42 can be easily provided by locating the additional liner 50 on the liner 16b. The space S2 is provided, thus external force is hardly applied to the additional wiring member 42, and misalignment of the location of the additional wiring member 42 is suppressed.

When the interior member is the liner 16b in the pillar 16 and the additional wiring member is the additional liner 50 covering the liner 16b from the side of the vehicle interior, the additional wiring member 42 can be easily added along the pillar 16 without detaching the liner 16b.

When the color of the surface of the additional interior member 30 or the additional liner 50 is the same type of color as that of the surface of the instrument panel 12 or the liner 16b, the additional interior member 30 or the additional liner 50 is hardly noticeable.

When the design texture of the surface of the additional interior member 30 or the additional liner 50 is the same as that of the surface of the interior member, the additional interior member 30 or the additional liner 50 is hardly noticeable.

When at least a part of the edge of the additional interior member 130 or the additional liner 50 follows the edge of the instrument panel 12 or the liner 16b, the additional interior member 130 or the additional liner 50 is hardly noticeable.

When the additional interior member 30 includes the impact absorption layer 32, the impact on the additional wiring member 22 is absorbed by the impact absorption layer 32, and hardly acts on the additional wiring member 22 located inside.

When the additional interior member 30 or the additional liner 50 keeps covering the additional wiring members 22 and 42 by the adhesive layer (for example, the double-sided adhesive tape 38 and the adhesive layer 58), the additional interior member 30 or the additional liner 50 can be easily attached to the instrument panel 12 or the liner 16b. For example, even when the configuration for attaching the additional interior member 30 or the additional liner 50 is not previously provided to the instrument panel 12 or the liner 16b, the additional interior member 30 or the additional liner 50 can be easily attached afterward.

### Modification Example

In the embodiment described above, the configuration according to the vehicle wiring system 20 and the configuration according to the vehicle wiring system 40 may be combined. For example, an additional interior member formed of a rigid member may cover the additional wiring member 22 on the instrument panel 12. In this case, the additional interior member may have a band-like shape following the route of the wiring member or have a shape covering the whole upper panel part 12a of the instrument panel 12. An additional interior member flexible enough to be able to be deformed along the surface of the liner 16b may cover the additional wiring member 22 on the liner 16b.

Described in the above embodiment is the example that the interior member is the instrument panel, the floor carpet, or the liner 16b of the pillar 16. The interior member may further be the center console 14 or a roof liner, for example.

The additional liner 50 may include the impact absorption layer.

Each configuration described in the embodiments and modification examples thereof can be appropriately combined as long as they are not contradictory.

### EXPLANATION OF REFERENCE SIGNS

10 vehicle
12 instrument panel
12a upper panel part
12b back panel part
13a instrument
13b steering wheel
14 center console
16 pillar
16D locking member
16Da locking claw
16a metal pillar
16b liner
16r metal reinforcement member
16rh locking hole
17 roof
17E roof electrical component
18 floor
18a floor carpet
20, 40 vehicle wiring system
22, 42, 222 additional wiring member
22C1, 22C2 connector
23, 43, 47a electrical wire
26 reinforcement
27, 47 wiring member
28 electrical component
30, 130, 230 additional interior member
31 solid layer
32 impact absorption layer
38 double-sided adhesive tape
50 additional liner
58 adhesive layer
232 hook-and-loop faster

1. A vehicle wiring system, comprising:
an interior member facing a vehicle interior;
an additional wiring member disposed on the interior member from a side of the vehicle interior; and
an additional interior member covering the additional wiring member from a side opposite to the interior member.

2. The vehicle wiring system according to claim 1, wherein
the additional wiring member includes a part from a first edge part toward a second edge part of the interior member, and
the additional interior member includes a part wholly covering the part between the first edge part and the second edge part in the additional wiring member.

3. The vehicle wiring system according to claim 1, further comprising
a wiring member covered by the interior member from the side of the vehicle interior.

4. The vehicle wiring system according to claim 1, wherein
the additional interior member is a sheet deformable along a surface shape of the interior member.

5. The vehicle wiring system according to claim 1, wherein
the additional interior member is a member having rigidity to an extent of being able to form a space for locating the additional wiring member between the interior member and the additional interior member.

6. The vehicle wiring system according to claim 5, wherein
the interior member is a liner covering a vehicle interior side of a pillar, and
the additional interior member is an additional liner covering the liner from the side of the vehicle interior.

7. The vehicle wiring system according to claim 1, wherein
a color of a surface of the additional interior member is a same type of color as a color of a surface of the interior member.

8. The vehicle wiring system according to claim 1, wherein design texture of the surface of the additional interior member is a same as design texture of the surface of the interior member.

9. The vehicle wiring system according to claim 1, wherein
at least a part of an edge of the additional interior member is along an edge of the interior member.

10. The vehicle wiring system according to claim 1, wherein
the additional interior member includes an impact absorption layer.

11. The vehicle wiring system according to claim 1, wherein
the additional interior member is kept in a state of covering the additional wiring member by an adhesive layer or a hook and loop fastener.

12. A vehicle additional wiring member, comprising:
an additional wiring member disposed on an interior member facing a vehicle interior; and
an additional interior member covering the additional wiring member from a side opposite to the interior member.
